(19) United States
(12) Patent Application Publication
(10) Pub. No.: US 2011/0239976 A1
(43) Pub. Date: Oct. 6, 2011

(54) CYLINDER BORE AND METHOD FOR PRODUCING THE SAME

(75) Inventor: Koji Kobayashi, Hagagun (JP)

(73) Assignee: HONDA MOTOR CO., LTD., Tokyo (JP)

(21) Appl. No.: 13/079,902

(22) Filed: Apr. 5, 2011

(30) Foreign Application Priority Data
Apr. 6, 2010 (JP) 2010-087963

(51) Int. Cl. F02F 1/00; B21K 3/00

(52) U.S. Cl. 123/193.2; 29/888.01

(57) ABSTRACT

A method for a cylinder bore having a sliding surface which slides with respect to a counter member includes forming the sliding surface on a molded block by a boring processing with respect to the molded block, crushing cavities at the sliding surface and in the vicinity thereof by plastic working after the boring processing, smoothing the sliding surface, and forming a coating having seizure resistance on the sliding surface after the plastic working.

### BACKGROUND OF THE INVENTION

1. Field of the Invention

The present invention relates to a cylinder bore used in the field of engines and a method for producing the same, and in particular relates to improvement of a sliding surface thereof.

2. Related Art

A cylinder bore includes a sliding surface which slides relatively with respect to a piston via an oil film. In the sliding surface, as a main object to improve seizure resistance and wear resistance by maintaining the oil film, a grooved shape such as cross hatching is formed by honing processing, and a coating is formed on a surface of the grooved shape. As a technique in practical use, a plating film is formed as a coating by wet plating processing such as Ni—SiC plating in which SiC particles are dispersedly contained in Ni metal.

Various improvements have been made to the above sliding surface. For example, Japanese Patent Application, First Publication No. 2005-69008 discloses a technique in which a DLC film (Diamond-Like Carbon film) having superior seizure resistance and low frictional properties is formed as the coating on a sliding surface of a cylinder bore. Furthermore, Japanese Patent Application, First Publication No. 10-237693 discloses a technique in which an alumite film is formed as a coating on a sliding surface of a cylinder bore, and the alumite film is processed by burnishing so that protrusions of a surface of the alumite film are made uniform.

### SUMMARY OF THE INVENTION

Since a cylinder block in which a cylinder bore is formed is produced by molding, cavities are dispersedly formed around the sliding surface. When a DLC film is formed as a coating, the DLC film does not closely contact the cavities, so that flaking of the DLC film may be initiated at a location on the cavity. Furthermore, a portion of the DLC film on the cavity may fall thereinto since the DLC film is crushed by a counter member, whereby cracking may occur. When a plating film is formed as a coating and is heated in an operation of an engine, moisture in the cavity is vaporized and expands, so that the plating film covering the sliding surface may be fractured, whereby imperfections may occur.

Therefore, forming the cavity must be inhibited so that the reliable durability of the cylinder bore can be improved. However, in a molding method for producing the cylinder block, it is impractical to improve quality of the moldings sufficiently to avoid forming the cavities completely. Furthermore, when a LPDC (Low Pressure Die Casting) method, by which moldings having relatively superior quality can be produced, is applied, although cavities can be greatly decreased, the decreased amount is insufficient to improve durability of the cylinder bore. In the LPDC method, productivity is greatly degraded compared to a HPDC (High Pressure Die Casting) method, whereby production cost is increased.

According to this circumference, cavities must be removed from the cylinder block in a working step after producing the cylinder block by the HPDC method. Then, in an involved method, a cylinder block is heated before forming a coating to a temperature in which plastic deformation thereof can be easily done, and the sliding surface of the cylinder bore is struck by a hammer, and thus, the cavities are removed. However, when this method is applied to a part such as a cylinder bore in which high circularity is required, deformation is generated in the part, so that quality of the product is degraded.

Therefore, an object of the present invention is to provide a cylinder bore and a method for producing the same in which cavities can be sufficiently removed without generating deformation, and durability can be improved.

The present inventors have researched the sliding surface of the cylinder bore intensively and repeatedly. As a result, the following knowledge was obtained. That is, selectivity of properties of the sliding surface can be improved by using a material having seizure resistance as a coating. Furthermore, it was found that cavities at the sliding surface and in the vicinity thereof can be crushed by plastic working before forming the coating, and the sliding surface can be smoothed. Thus, the present invention was completed.

A method for producing a cylinder bore of the present invention is the method for producing the same having a sliding surface which slides with respect to a counter member and includes forming the sliding surface on a molded block by a boring processing with respect to the molded block, crushing cavities on the sliding surface and in the vicinity thereof by plastic working after the boring processing, smoothing the sliding surface, and forming a coating having seizure resistance on the sliding surface after the plastic working.

In the method for producing a cylinder bore of the present invention, the cavities on the sliding surface and in the vicinity thereof are crushed by the plastic working with respect to the sliding surface before forming the coating, and the sliding surface is smoothed. Therefore, imperfections such as a cavity can be sufficiently avoided, so that flaking and cracking of the coating on the sliding surface can be removed. As a result, reliable durability of the cylinder bore can be improved. Furthermore, striking on the sliding surface by a hammer is not necessary. Therefore, generation of deformation can be inhibited, whereby quality of the product can be improved.

The method for producing a cylinder bore of the present invention can be applied in various embodiments. For example, a Ni—SiC Film containing SiC at the area ratio of 5 to 50% can be used. When the area ratio of SiC in the coating is less than 5%, toughness as the plating film cannot be obtained. When the area ratio of the SiC in the coating is greater than 50%, seizure resistance is degraded. Therefore, the area ratio of SiC in the coating is preferably 5 to 50%. Furthermore, a DLC film (Diamond-Like Carbon film) can be used as the coating having seizure resistance. In this condition, not only the improved seizure resistance, but also improved wear resistance and reduced friction loss, can be obtained. An intermediate layer may be formed between the DLC film and the surface of the cylinder bore.

For example, when cylindricity of the cylinder bore is set at 30 μm or less, consumption of lubricating oil can be reduced, and the required performance such as prevention of galling on the sliding surface can be obtained. Therefore, the cylindricity of the cylinder bore is preferably set at 30 μm or less. When the cylindricity of the cylinder bore is set at 20 μm or less, sealing function can be maintained without large modification of the producing condition, so that further high performance of the cylinder bore can be obtained. Therefore, the cylindricity of the cylinder bore is preferably 20 μm or less. The cylindricity is the difference between the minimum and the maximum values of the pore diameters of the cylinder bore after the plastic working.

Plastic deformation amount in the plastic working is set as follows so that the cylindricity of the cylinder bore can be set at 30 μm or 20 μm. The plastic deformation amount is the maximum difference of the values between the radial diameters of the cylinder bore before the plastic working and that of the cylinder bore after the plastic working.

For example, in applying the present invention to a single cylinder engine or a V-two engine, the plastic deformation amount in the plastic working of the cylinder bore is set at 5 to 145 μm so as to set the cylindricity of the cylinder bore at 30 μm or less, and is set at 5 to 85 μm so as to set the cylindricity thereof at 20 μm or less.

In applying the present invention to an in-line two-cylinder engine or a V-four engine, the plastic deformation amount in the plastic working of the cylinder bore is set at 5 to 120 μm so as to set the cylindricity of the cylinder bore at 30 μm or less, and is set at 5 to 65 μm so as to set the cylindricity thereof at 20 μm or less.

In applying the present invention to an in-line three-cylinder engine or a V-six engine, the plastic deformation amount in the plastic working of the cylinder bore is set at 5 to 125 μm so that the cylindricity of the cylinder bore can be set at 30 μm or less, and is set at 5 to 70 μm so as to set the cylindricity thereof at 20 μm or less.

In applying the present invention to an in-line four-cylinder engine or a V-eight engine, the plastic deformation amount in the plastic working of the cylinder bore is set at 5 to 90 μm so as to set the cylindricity thereof at 30 μm or less, and is set at 5 to 50 μm so as to set the cylindricity thereof at 20 μm or less.

In applying the present invention to an in-line-type engine having the plural cylinders or a V-type engine having plural cylinders which are disposed at both sides of the V shape, the plastic deformation amount in the plastic working of the cylinder bore is set at 5 to 90 μm, so that the cylindricity of the cylinder bore which is lastly processed by the plastic working (in a V-type engine, both lastly processed cylinders at both sides of the V shape) can be set at 30 μm or less. Furthermore, the plastic deformation amount in the plastic working is set at 5 to 50 μm, so that the cylindricity of the cylinder bore lastly processed by the plastic working (in a V-type engine, both lastly processed cylinders at both sides of the V shape) can be set at 20 μm or less. The plastic working can be applied with various plastic working manners, for example, a roller burnishing method can be used. When the surface roughness Ra is 0.1 μm or less, the friction can be greatly reduced. Therefore, the surface roughness Ra is preferably set at 0.1 μm or less. In this case, the plastic deformation amount in the plastic working is set at 5 μm or more so that the surface roughness Ra is 0.1 μm or less.

A cylinder bore of the present invention can be obtained by a method for producing the same of the present invention. That is, the cylinder bore of the present invention includes a sliding surface which slides with respect to a counter member, cavities formed in the cylinder bore, and a coating formed on the sliding surface and having seizure resistance, in which the sliding surface is smoothed by crushing the cavities at the sliding surface and in the vicinity thereof. The cylinder bore of the present invention can obtain the same effect as that of the method for producing the cylinder bore of the present invention.

According to the cylinder bore and the method for producing the same of the present invention, since imperfections such as cavities can be sufficiently removed, clucking and flaking of the coating can be avoided, whereby reliable durability can be improved.

### BRIEF DESCRIPTION OF DRAWINGS

FIGS. 1A, 1B and 1C show each working step of a method for producing a cylinder bore in accordance with an embodiment of the present invention, FIG. 1A is a schematic cross-sectional view showing a condition of a sliding surface of the cylinder bore after boring processing, FIG. 1B is a schematic cross-sectional view showing the condition of the sliding surface of the cylinder bore after plastic working and FIG. 1C is a schematic cross-sectional view showing the condition of the sliding surface of the cylinder bore after forming a coating.

FIG. 2 is a cross-sectional view showing a schematic structure of the plastic working applied with a roller burnishing method as a production method for the cylinder bore in accordance with the embodiment of the present invention.

FIG. 3 is a graph showing a relationship between surface roughness Ra (μm) and burnishing amount of the cylinder bore before the plastic working and after the plastic working in accordance with an example of the present invention.

FIG. 4 is a graph showing the relationship between the surface roughness Ra (μm) and the cylindricity (μm) of the cylinder bores in the plastic working in each of evaluations of the present invention.

FIG. 5 shows a method for calculating the cylindricity of the cylinder bore of the embodiment of the present invention.

FIGS. 6A and 6B show the sequence of the plastic workings of the cylinder bores in accordance with the embodiment of the present invention, FIG. 6A snows the sequence in a case of three bores evaluation and 6B shows the sequence in a case of four bores evaluation.

### DESCRIPTION OF THE PREFERRED EMBODIMENTS

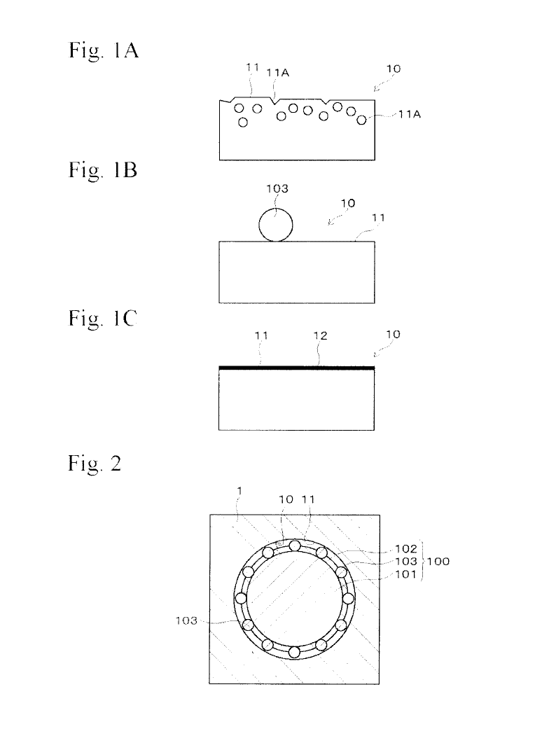

An embodiment of the present invention is explained hereinafter referring to the drawings. FIGS. 1A, 1B and 1C show each working step of a production method for a cylinder bore 10 in accordance with an embodiment of the present invention, FIG. 1A is the schematic cross-sectional view showing the condition of a sliding surface 11 of the cylinder bore 10 after boring processing, FIG. 1B is the schematic cross-sectional view showing the condition of the sliding surface 11 of the cylinder bore 10 after burnishing processing and FIG. 1C is the schematic cross-sectional view showing the condition of the sliding surface 11 of the cylinder bore 10 after forming a coating 12. In FIGS. 1A, 1B and 1C, the sliding surfaces 11 of the cylinder bores 10 and the vicinities thereof are partially shown. FIG. 2 is a cross-sectional view showing a condition in which the sliding surface 11 is processed by the burnishing in FIG. 1B.

A cylinder block (a molded block) consisted of, for example, a cylinder block composed of aluminum (Al) is obtained by molding using a die. The cylinder bore 10 having the sliding surface 11 is formed by the boring processing with respect to the cylinder block. As shown in FIG. 1A, cavities 11A formed in molding are dispersed at the sliding surface 11 of the cylinder bore 10 and in the vicinity thereof.

Next, the cavities 11A are crushed by the plastic working with respect to the sliding surface 11 of the cylinder bore 10, and the sliding surface 11 of the cylinder bore 10 is smoothed. Specifically, as a plastic working, the roller burnishing method is applied.

In a burnishing tool 100 used for the roller burnishing method, a mandrel 101 is rotatably provided on the inner circumferential surface of a retainer 102, and rollers 103 rolled by rotation of the mandrel 101 are provided to the retainer 102 at a predetermined interval. The rollers 103 are partially protruded beyond the outer circumferential surface of the retainer 102. The reference numeral “1” in FIG. 2 is a portion of the cylinder block.

In a case in which the burnishing tool 100 is applied on the inner circumferential surface of the cylinder bore 10, when the mandrel 101 is rotated, the rotational torque of the mandrel 101 is transmitted to the rollers 103, so that plastic deformation of the sliding surface 11 of the cylinder bore 10 occurs. By this processing, the cavities 11A formed on the sliding surface 11 of the cylinder bore 10 and in the vicinity thereof are crushed, and the sliding surface 11 of the cylinder bore 10 is smoothed (mirror finished).

The burnishing amount (the plastic deformation amount) is preferably 5 μm or more so that the surface roughness Ra of the sliding surface 11 is 0.1 μm or less. The burnishing amount is preferably 5 to 85 μm so that a cylindricity of the cylinder bore 10 is 30 μm or less. The burnishing amount is preferably 5 to 50 μm so that the cylindricity of the cylinder bore 10 is 20 μm or less. When the cylinder block 1 is provided with plural cylinder bores 10, each required value of the cylindricity can be obtained by setting the burnishing amounts such as above.

Then, the coating 12 is formed on the sliding surface 11 of the cylinder bore 10. As the material of the coating 12, materials having high seizure resistance such as DLC, Ni—SiC (nickel-silicon carbide), Cr—N (chromium nitride), Au (gold), Ag (silver) and Cu (copper) are used. When the coating 12 having high seizure resistance cannot be prepared, metallic adhesion easily occurs in sliding between the cylinder bore 10 made of, for example, Al (aluminum) and a piston, whereby seizure may occur, but seizure can be avoided by forming the coating 12.

When a Ni—SiC film is used as the coating 12, SiC is preferably contained at an area ratio of 5 to 50%. When the area ratio of SiC is within the limitation, toughness as the plating film can be obtained and seizure resistance can be sufficient. DLC has superior seizure resistance and low frictional properties, so that DLC is used as the material of the coating 12. In using DLC, the DLC film is formed by, for example, a plasma-CVD (Chemical Vapor Deposition) method or a PVD (Physical Vapor Deposition) method. In using Cr—N, a Cr—N film is formed by, for example, vapor deposition.

According to the present embodiment, the cavities 11A at the sliding surface 11 and in the vicinity thereof are crushed by the plastic working with respect to the sliding surface 11 before forming the coating 12, and the sliding surface 11 is smoothed. Therefore, imperfections such as the cavities 11A can be sufficiently removed therefrom, so that flaking and cracking of the coating 12 can be avoided. As a result, reliable durability thereof can be improved. Furthermore, striking on the sliding surface 11 by a hammer is not necessary, so that generating deformation can be inhibited. As a result, quality of the product can be improved.

The present invention is explained in detail hereinafter referring to specific examples. In the examples, the cylinder bores having sliding surfaces were formed in a way that a cylinder block obtained by molding was processed by the boring using the same method as the present embodiment. Next the sliding surfaces were processed by the plastic working using the roller burnishing. The examples obtained by this method were evaluated about surface roughness control and the cylindricity, whereby the best condition of the plastic working was examined.

### 1. Example 1

### Evaluation of Surface Roughness Control

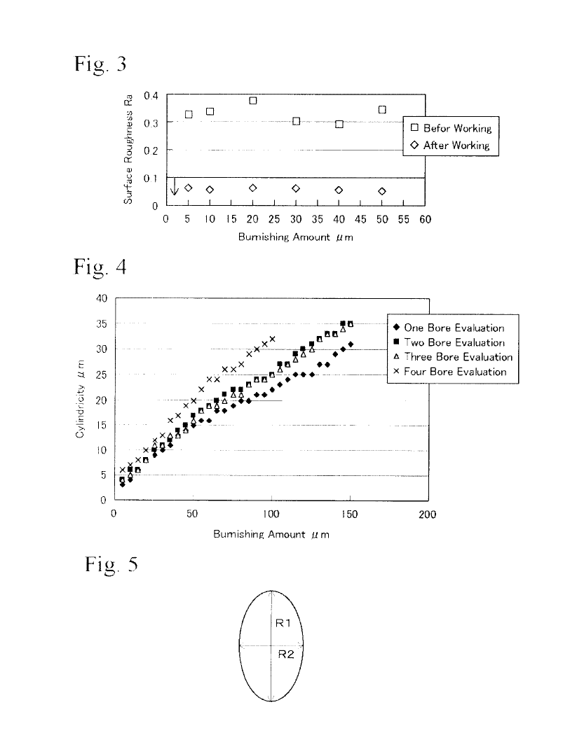

In Example 1, the surface roughness control was evaluated. In the boring processing, plural cylinder bores having substantially the same degree of surface roughness were obtained. In the plastic workings of the cylinder bores, the relationships between the surface roughness Ra (μm) and the burnishing amount before and after the plastic working were examined under conditions in which the burnishing amounts were varied. The results of these examinations are shown in FIG. 3.

One cylinder bore for one cylinder block was processed by the plastic working in Example 1. In FIG. 3, the burnishing amount was determined as the difference between the diameter of the cylinder bore before the plastic working and the diameter of the burnishing tool 100 (the dimension from the radial center of the mandrel 101 to the outermost circumferential surface of the roller 103). In the evaluation of the surface roughness control, friction can be greatly reduced when the surface roughness Ra is 0.1 μm or less, so that the required value of the surface roughness was set at 0.1 μm or less. When the value of the surface roughness Ra after the plastic working was within this limitation, the sample was good. When the value of the surface roughness Ra after the plastic working was out of range, the sample was not good.

As shown in FIG. 3, when the burnishing amount was 5 μM or more, the surface roughness Ra was 0.1 μm or less, the required values could be obtained, and it was confirmed that required smoothness could be obtained. In this case, it was also confirmed that the values of the surface roughness Ra after the plastic working were substantially constant and did not depend on the burnishing amount. Furthermore, since the optimum burnishing amount was varied according to the surface roughness before the plastic working, even if the burnishing amount was less than 5 the required smoothness could be obtained in a case.

### 2. Example 2

### Evaluation of Cylindricity

In the next example, cylindricity was evaluated. In the boring processing, the cylinder blocks provided with cylinder bores having substantially the same surface roughness were prepared. In the plastic working of the cylinder bore, the relationships between the cylindricity (μm) and the burnishing amounts (μm) of the cylinder bores after the plastic working were obtained in a condition in which the burnishing amounts were varied, and the cylindricity was examined. The burnishing amount was determined as the maximum value of the difference between the radial diameters of the cylinder bores before and after the plastic working. As shown in FIG. 5, the cylindricity was determined as the difference between the maximum value R1 of the diameter and the minimum value R2 of the diameter of the cylinder bore after the plastic working.

Specifically, the cylindricities were evaluated in the following conditions. The cylindricities of the structures in which one cylinder bore for one cylinder block (one-bore evaluation), two cylinder bores for one cylinder block (two-bore evaluation), three cylinder bores for one cylinder block (three-bore evaluation) and four cylinder bores for one cylinder block (four-bore evaluation) were processed by the plastic working were evaluated. For the explanation of these evaluations, the relationships between the cylindricities (μm) and burnishing amounts (μm) of the cylinder bores after the plastic working are shown in Table 1 and FIG. 4. The graph shown in FIG. 4 was made based on the data in Table 1. The cylindricity after the plastic working in the plural bores evaluation was determined as that of the cylinder bore which was lastly processed by the plastic working.

TABLE 1

| Burnishing | | | | |
|---|---|---|---|---|
| Amount | Cylindricity μm | | | |
| μm | 1 Bore | 2 Bores | 3 Bores | 4 Bores |
| 5 | 3 | 4 | 4 | 6 |
| 10 | 4 | 6 | 5 | 7 |
| 15 | 6 | 6 | 6 | 8 |
| 20 | 8 | 8 | 8 | 10 |
| 25 | 9 | 10 | 11 | 12 |
| 30 | 10 | 11 | 11 | 13 |
| 35 | 11 | 12 | 13 | 16 |
| 40 | 13 | 14 | 13 | 17 |
| 45 | 14 | 15 | 14 | 19 |
| 50 | 15 | 17 | 16 | 20 |
| 55 | 16 | 18 | 18 | 22 |
| 60 | 16 | 19 | 19 | 24 |
| 65 | 18 | 20 | 19 | 24 |
| 70 | 18 | 21 | 20 | 26 |
| 75 | 19 | 22 | 21 | 26 |
| 80 | 20 | 22 | 21 | 27 |
| 85 | 20 | 23 | 23 | 29 |
| 90 | 21 | 24 | 24 | 30 |
| 95 | 21 | 24 | 24 | 31 |
| 100 | 22 | 25 | 25 | 32 |
| 105 | 23 | 27 | 26 | — |
| 110 | 24 | 27 | 27 | — |
| 115 | 25 | 29 | 28 | — |
| 120 | 25 | 30 | 29 | — |
| 125 | 25 | 31 | 30 | — |
| 130 | 27 | 32 | 32 | — |
| 135 | 27 | 33 | 33 | — |
| 140 | 29 | 33 | 33 | — |
| 145 | 30 | 35 | 34 | — |
| 150 | 31 | 35 | 35 | — |

When the cylindricity was 30 μm or less, the required performance such as reducing consumption of a lubricating oil and avoiding galling on the sliding surface could be obtained, so that the required value was set at 30 μm or less (first required value). Furthermore, when the cylindricity was 20 μm or less, the sealing function could be maintained without large modification of the production conditions, and the high performance of the cylinder bore could be further improved, so that the more preferable required value than the first required value was set at 20 μm or less (second required value).

By using the cylinder block having one cylinder bore, the cylinder bore was processed by the plastic working and was evaluated, so that the cylindricity in this case was not affected by the plastic working of an adjacent cylinder bore, but only affected by the plastic working of itself.

As shown in Table 1 and FIG. 4, even though the cylindricity of the cylinder bore after the plastic working was gradually degraded according to increase of the burnishing amount, the first required value (30 μm or less) of the cylindricity could be obtained when the burnishing amount was 5 to 145 μm. The second required value (20 μm or less) of the cylindricity of the cylinder bore could be obtained when the burnishing amount was 5 to 85 μm.

Therefore, in applying the present invention to a single cylinder engine or a V-two engine, the burnishing amount was set at 5 to 145 μm so as to set the cylindricity of the cylinder bore at 30 μm or less and was set at 5 to 85 μm so as to set the cylindricity thereof at 20 μm or less.

By using the cylinder block having two cylinder bores, the cylinder bores were processed by the plastic working and were evaluated, so that the cylindricity in this case was affected not only by the plastic working of itself but also by that of the adjacent cylinder bore and the effects remained in the cylindricity.

As shown in Table 1 and FIG. 4, according to increase of the burnishing amount, the cylindricity of the cylinder bore lastly processed by the plastic working was furthermore degraded than that of a case in one bore evaluation. However, the first required value (30 μm or less) of the cylindricity could be obtained when the burnishing amount was 5 to 120 μm. The second required value (20 μm or less) of the cylindricity could be obtained when the burnishing amount was 5 to 65 μm.

Therefore, in applying the present invention to an in-line two-cylinder engine or a V-four engine, the burnishing amount was set at 5 to 120 μm so as to set the cylindricity at 30 μm or less, and was set 5 to 65 μm so as to set the cylindricity at 20 μm or less.

By using the cylinder block having three cylinder bores, the cylinder bores were processed by the plastic working, and the cylinder bores after the plastic working were evaluated, so that the cylindricity in this case was affected not only by the plastic working of itself but also by that of the adjacent cylinder bore, of which the condition was the same as the condition in the two-bore evaluation.

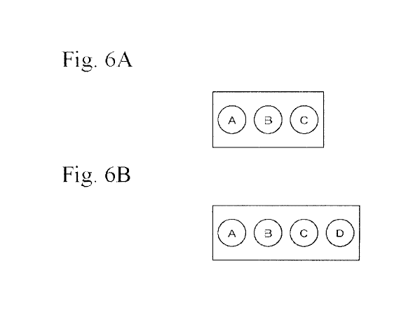

In this condition, the sequence of the plastic working of the cylinder bores was examined so that the effects by the plastic working of the adjacent cylinder bore could be minimized. As a result of this examination, when the three cylinder bores A to C of the cylinder block shown in FIG. 6A were sequentially processed by the plastic working in order starting from the left (that is, in order of the cylinder bore A, the cylinder bore B and the cylinder bore C) or from the right (that is, in order of the cylinder bore C, the cylinder bore B and the cylinder bore A), each of cylinder bores was sequentially affected by the plastic working of the adjacent cylinder bore. Therefore, the effect was sequentially maintained in each of cylinder bores, so that all the effects were maintained in the lastly processed cylinder bore. Therefore, the cylindricity of the cylinder bore lastly processed by the plastic working was deteriorated.

Therefore, in the three cylinder bores A to C of the cylinder block shown in FIG. 6A, when the plastic working was performed in an irregular order of the cylinder bore B, the cylinder bore A and the cylinder bore C or in order of the cylinder bore B, the cylinder bore C and the cylinder bore A, the cylindricity of the cylinder bore lastly processed by the plastic working was preferable compared to that of the lastly processed cylinder bore obtained in the above regular order.

The relationship between the cylindericity (μm) and the burnishing amount (μm) of the cylinder bore lastly processed by the plastic working in the irregular order starting from the middle one is shown in Table 1 and FIG. 4. As shown in Table 1 and FIG. 4, according to increase of the burnishing amount, the cylindricity of the cylinder bore lastly processed by the plastic working was substantially the same as that of the cylinder bore in a case of the two-bore evaluation. Specifically, when the burnishing amount was 5 to 125 μm, the first required value (30 μm or less) of the cylindericity could be obtained. Furthermore, when the burnishing amount was 5 to 70 μM, the second required value (20 μm or less) of the cylindericity could be obtained.

Therefore, in applying the present invention to an in-line three-cylinder engine or a V-six engine, the burnishing amount was set at 5 to 125 μm so as to set the cylindricity at 30 μm or less, and was set at 5 to 70 μm so as to set the cylindricity at 20 μm or less.

By using the cylinder block having four cylinder bores, the sequence of the plastic working was examined so that the effects from the plastic working of the adjacent cylinder bore could be minimized. As a result. when the cylinder bores A to D of the cylinder block shown in FIG. 6B were processed by the plastic working in the regular order starting from the left (that is, in order of the cylinder bore A, the cylinder bore B, the cylinder bore C and the cylinder bore D) or from the right (that is, in order of the cylinder bore D, the cylinder bore C, the cylinder bore B and the cylinder bore A), each cylinder bore was sequentially affected by the plastic working of the adjacent cylinder bore, whereby each effect was sequentially maintained in each cylinder bore, so that all the effects were maintained in the cylinder bore lastly processed by the plastic working. Therefore. the cylindricity of the cylinder bore lastly processed by the plastic working was deteriorated as well as the cylindricity in the case of the three-bore evaluation.

When the four cylinder bores A to D of the cylinder block shown in FIG. 6B were processed by the plastic working and when the plastic working was performed in an irregular order of the cylinder bore B, the cylinder bore A, the cylinder bore C and the cylinder bore D or in order of the cylinder bore C, the cylinder bore D, the cylinder bore B and the cylinder bore A, the cylindricity of the cylinder bore lastly processed by the plastic working was preferable compared to that of the cylinder bore lastly processed by the plastic working in the regular order starting from the left or from the right.

The relationship between the cylindricity (μm) and the burnishing amount (μm) of the cylinder bore processed by the plastic working in the irregular order were shown in Table 1 and FIG. 4. As shown in Table 1 and FIG. 4, according to increase of the burnishing amount, the cylindricity of the cylinder bore lastly processed by the plastic working was degraded compared to the cylindricity in the case of the three bores evaluation. However, when the burnishing amount was 5 to 90 μm, the first required value (30 μm or less) of the cylindericity could be obtained. Furthermore, when the burnishing amount was 5 to 50 μm, the second required value (20 μm or less) of the cylindericity could be obtained.

Therefore, in applying the present invention to an in-line four-cylinder engine or a V-eight engine, the burnishing amount was set at 5 to 90 μm so as to set the cylindricity at 30 μm or less, and was set at 5 to 50 μm so as to set the cylindricity at 20 μm or less.

In the three-bore evaluation or evaluation of four or more bores in Example 2, the cylinder bores were processed by the plastic working in the predetermined order. As a result, simultaneous performing of the plastic workings with respect to all cylinder bores was preferable as the method for obtaining the favorable cylindricity of all cylinder bores.

What is claimed is:

1. A method for producing a cylinder bore having a sliding surface which slides with respect to a counter member, comprising:
forming the sliding surface on a molded block by boring processing with respect to the molded block;
crushing cavities at the sliding surface and in the vicinity thereof by plastic working after the boring processing;
smoothing the sliding surface; and
forming a coating having seizure resistance on the sliding surface after the plastic working.

2. The method for producing a cylinder bore according to claim 1, wherein a Ni—SiC film containing SiC at an area ratio of 5 to 50% is used as the coating.

3. The method for producing a cylinder bore according to claim 1, wherein a DLC film is used as the coating.

4. The method for producing a cylinder bore according to claim 1, wherein the plastic working is performed at a rate of deformation of 5 to 145 μm in applying to a one-cylinder engine or a V-two engine.

5. The method for producing a cylinder bore according to claim 1, wherein the plastic working is performed at a rate of deformation of 5 to 85 μm in applying to a one-cylinder engine or a V-two engine.

6. The method for producing a cylinder bore according to claim 1, wherein the plastic working is performed at a rate of deformation of 5 to 120 μm in applying to an in-line two-cylinder engine or a V-four engine.

7. The method for producing a cylinder bore according to claim 1, wherein the plastic working is performed at a rate of deformation of 5 to 65 μm in applying to the in-line two-cylinder engine or the V-four engine.

8. The method for producing a cylinder bore according to claim 1, wherein the plastic working is performed at a rate of deformation of 5 to 125 μm in applying to an in-line three-cylinder engine or a V-six engine.

9. The method for producing a cylinder bore according to claim 1, wherein the plastic working is performed at a rate of deformation of 5 to 70 μm in applying to the in-line three-cylinder engine or the V-six engine.

10. The method for producing a cylinder bore according to claim 1, wherein the plastic working is performed at a rate of deformation of 5 to 90 μm in applying to an in-line four-cylinder engine or a V-eight engine.

11. The method for producing a cylinder bore according to claim 1, wherein the plastic working is performed at a rate of deformation of 5 to 50 μm in applying to the in-line four-cylinder engine or the V-eight engine.

12. The method for producing a cylinder bore according to claim 1, wherein the plastic working is performed with roller-burnishing processing.

13. A cylinder bore comprising:
a sliding surface which slides with respect to a counter member;
cavities formed in the cylinder bore; and
a coating formed on the sliding surface and having seizure resistance:
wherein the sliding surface is smoothed by crushing the cavities on the sliding surface and in the vicinity thereof.

14. The cylinder bore according to claim 13, wherein the coating is a Ni—SiC film containing SiC at an area ratio of 5 to 50%.

15. The cylinder bore according to claim 13, wherein the coating is a DLC film.
